(19) United States
(12) Patent Application Publication
(10) Pub. No.: US 2026/0035166 A1
(43) Pub. Date: Feb. 5, 2026

(54) MULTILAYER COMPOSTABLE FILM FOR SEALING A CAPSULE FOR MAKING BEVERAGES

(71) Applicant: GUALA PACK S.P.A., Castellazzo Bormida (Alessandria) (IT)

(72) Inventors: Fabio TANSINI, Castellazzo Bormida (Alessandria) (IT); Gino TANSINI, Castellazzo Bormida (Alessandria) (IT); Lorenzo ZAMIRRI, Castellazzo Bormida (Alessandria) (IT); Riccardo ZAMMORI, Castellazzo Bormida (Alessandria) (IT)

(21) Appl. No.: 19/099,126

(22) PCT Filed: Jul. 20, 2023
(86) PCT No.: PCT/IB2023/057409

§ 371 Date: Jan. 28, 2025

(30) Foreign Application Priority Data
Jul. 29, 2022 (IT) 102022000016095

(51) Int. Cl. B65D 85/804; B29C 48/08; B29C 48/154; B29K 511/12; B29L 31/00; B32B 5/02; B32B 27/12; B32B 27/18; B32B 29/02; B65D 65/40; B65D 65/46; D04H 1/435

(52) U.S. Cl. CPC B65D 85/8061; B29C 48/08; B29C 48/154; B32B 5/022; B32B 27/12; B32B 27/18; B32B 29/02; B65D 65/40; B65D 65/466; D04H 1/435; B29K 2511/12; B29K 2995/0037; B29L 2031/7174; B32B 2262/0276; B32B 2307/7163; B32B 2307/718; B32B 2307/7376; B32B 2307/748; B32B 2439/40; B32B 2439/70; B65D 2565/382; B65D 2565/387; D10B 2505/10

(57) ABSTRACT

A method for manufacturing a compostable film for sealing a capsule for making beverages involves arranging an outer barrier layer made of a compostable material, the compostable material being paper, or regenerated cellulose, arranging a filtering element, and extruding and casting, directly onto the outer barrier layer, an inner layer, intended to come into contact with the capsule to be sealed and made of a compostable biopolymer with heat-sealing properties so that the filtering element is at least partially incorporated in the compostable biopolymer.

### DESCRIPTION

The object of the present invention is an easily breakable, multilayer, compostable film, for the packaging of foods and beverages, and in particular for making the lid of a capsule for making infusion or soluble beverages (for example, coffee, tea and soluble herbal teas). The object of the invention is also a capsule having a lid made using such a film, either an outer lid (top lid) or an inner lid (internal sealing wall).

In the sector, capsules are known for the packaging of concentrated products (e.g., in the form of powder, granules, leaves) in predetermined, single-use doses, for the impromptu preparation of beverages (such as tea, coffee, herbal teas, milk, chocolate, etc.) by means of the introduction, into said capsule, of a fluid under pressure (mostly hot water). Said flow of hot water, delivered by an extraction machine, passes through the essence to be infused or dissolved contained inside the capsule, which results in the impromptu preparation of the beverage.

Different types of automatic or semi-automatic beverage preparation machines are known in the industry.

A first type of machine envisages the perforation of the capsule on both sides, in order to allow the pressurized fluid to be injected into the cup on one side, and the beverage to flow out from the opposite side. This first type of machine is intended for capsules comprising a cup that is closed on both sides, respectively by a bottom and a lid (top lid). In such applications, the high temperature and high pressure extracted water enters the base of the capsule and emerges from the lid which opens in perforating itself at various points against an appropriate element of the exaction machine. In such a case the structure of the lid, which is generally multilayer, must therefore firstly allow for the correct opening and subsequently the correct emergence of the product.

A second type of machine envisages perforating the capsule only on one side to allow pressurized fluid to be injected into the cup. This second type of machine is in fact intended for capsules comprising a cup equipped with an outlet for the beverage on one side and a closing lid on the opposite side, as well as its own inner opening means. Said opening means, usually in the form of cutting or piercing tips or contours, are activated by increasing the pressure within the cup so as to pierce or tear an inner sealing disc (internal sealing wall) and thereby allow the beverage to escape from the outlet opening at the bottom of the cup.

Those capsules that are actually on the market have various geometries, according to the dispensing machine whereinto they are inserted and according to the relative delivery method. One element that is common to those capsules that are on the market is the perforation of the lid, be it an inner or an outer lid, this being fundamental insofar as it makes it possible for the high pressure and high temperature beverage to emerge from the capsule. As mentioned above the structure of the multilayer lid must therefore firstly allow for the correct opening and subsequently the correct emergence of the product. In the case of external lids, or top lids, the multilayer is applied to the edge of the capsule body full of foodstuff product (in powder of granular form) by means of heat sealing or similar techniques.

Those lids that are actually on the market have standard multilayer structures, for example PET-PETALOX-PP, PET-PET-PP, PET-PET-PE or similar. Generally, in cases wherein it is also necessary to filter the beverage being dispensed from the capsule, the structure consists of three different materials: a first barrier layer, a second filtering layer and a non-compostable adhesive in between the two.

Such structures have some disadvantages. Above all, these are non-recyclable multi-material structures resulting in environmental impacts. Furthermore, such structures require the adoption of adhesives in order to join together the different layers of material that constitute the multilayer, according to current regulations they are not suitable for coming into contact with foodstuffs. Although with the capsule intact, there is no direct contact between the adhesive and the powder contained within the capsule body, some form of contamination at the extraction stage cannot a priori be ruled out insofar as the high temperature and high pressure extracted water, in passing through the multilayer structure of the lid, may be contaminated by substances/additives that are present within the formulation of such adhesives.

Lids have recently been introduced onto the market that are made from a compostable material, which however, only partially obviate the above mentioned disadvantages. In fact, such multilayer structures nonetheless include the use of adhesives and do not resolve the problem of possible contamination of the beverage during the extraction step. Furthermore, common compostable materials often do not have degrees of brittleness that are suitable for the application and risk compromising the correct opening of the capsule. The object of this invention is to provide a film for making the lid of a capsule, be it an inner or an outer lid, that solves the problems of the prior art while taking into account the needs of the industry.

In particular, the object of the present invention is that of supplying a compostable film for the manufacture of the lid of a capsule, a film that is preferably free of adhesives and that ensures the correct opening thereof by means of perforation.

This object is achieved by a compostable film according to claim 1. The dependent claims describe preferred embodiments of the invention.

The features and the advantages of the invention will appear more clearly from the following description, made by way of an indicative and non-limiting example with reference to the accompanying figures, wherein:

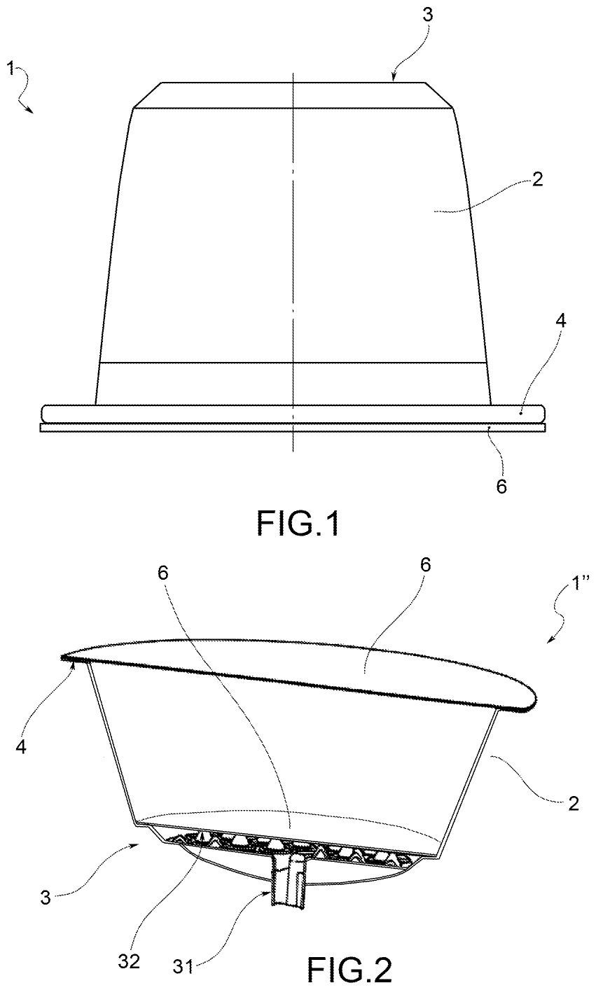

FIG. 1 show an example of a capsule for making infusion or soluble beverages, provided with a lid according to the present invention;

FIG. 2 show a further example of a capsule for making infusion or soluble beverages, provided both with an outer lid and an inner lid according to the present invention;

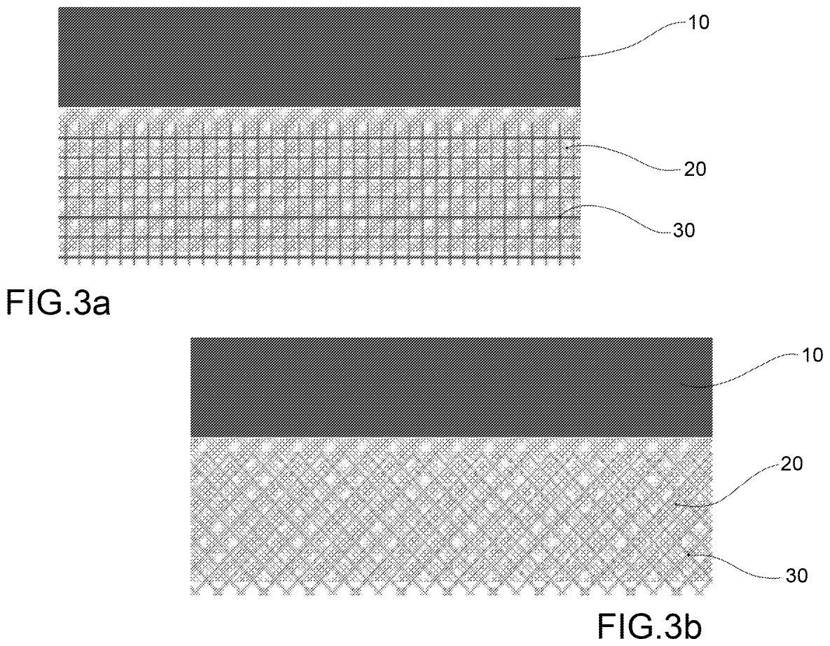

FIGS. 3a, 3b, 4a, 4b, 5a, 5b, 6a and 6b show exemplary embodiments of film for a lid according to the present invention, also comprising a filtering element that is incorporated in the inner layer.

With reference to the attached figures, a capsule infusion or soluble beverages is shown, for making indicated by the reference number 1.

The capsule 1 comprises a cup-shaped body 2 suitable for defining an inner volume V wherein at least one substance to be infused or dissolved is typically contained in powder or granular form.

The cup-shaped body 2 is provided on one side, with a bottom 3 and, on the opposite side, with an opening defined by an externally projecting edge 4. The capsule 1′ comprises a lid 6 fastened to the edge 4 for sealing the capsule. In one usage example of the capsule, the high temperature and high pressure extracted water enters the base 3 of the cup-shaped body 2 and emerges from the lid 6 which opens in perforating itself at various points against an appropriate element of the exaction machine.

In a further exemplary embodiment, shown in FIG. 2, the capsule 1″ comprises a cup-shaped body 2 provided, on one side, with an open base 3 with a beverage delivery jet 31, and on the other side, an opening defined by an edge 4 projecting towards the outside. An outer lid 6 is fastened to the edge 4 for sealing the capsule 1 above, and an inner lid 6 is fastened within the cup-shaped body 2 for sealing the capsule 1″ below. In one usage example of the capsule 1″, the high temperature and high pressure extracted water, enters from the outer lid 6, passes through the substance to be infused, pushes the inner lid 6 so as to open itself against the opening means 32 within the capsule and emerges from the jet 31 onto the base of the cup-shaped body 2.

The object of the present invention is a compostable, easily broken, multilayer film that is preferably devoid of adhesives for making a lid 6, be it an inner or an outer lid, for a compostable capsule for making beverages. The film is a compostable multilayer, preferably a laminated multilayer, comprising two layers, and in particular one outer layer 10, one inner layer 20 intended to make contact with the cup in order to seal the capsule 1.

The outer layer 10 is made of a compostable material. The outer layer 10 is made of paper and/or regenerated cellulose, or else biopolymer. For example, the outer layer 10 is made of paper, joined by means of adhesive to regenerated cellulose.

The outer layer 10 preferably has gas, light and steam barrier properties. For example, it has oxygen, humidity, water, fats, aromas and light barrier properties. Such properties may alternatively derive from processing that does not include surface treatments, or else from surface treatments, such as for example metallization, that do not affect the compostability thereof.

The outer layer 10 has appropriate brittleness features necessary for the application, breakage that is to be understood, for example, as the least possible elongation following breakage and perforation on the part of the perforating elements of the dispensing machine.

The outer layer 10 preferably has a uniform thickness of between 10 μm and 100 μm, preferably between 19 μm and 85 μm.

In one embodiment the outer layer 10 is made of paper. Preferably, the paper has barrier properties deriving solely from the dense adhesion of the paper microfibers and not from the depositing of chemical lacquers or coating or metallization treatments. Furthermore, the paper is not comparable to a vegetable parchment that is to say it does not include the use of sulfuric acid and/or zinc chloride.

In one embodiment, the barrier properties of the paper may be incremented by means of appropriate surface processes (such as, for example, metallization) that do not affect the compostability of the paper itself according to current standards.

In one embodiment the outer layer 10 is made of regenerated cellulose with barrier properties. The regenerated cellulose comprises a cellulose-based central layer 90 and two external coverings 91, for example based upon PVDC, PVOH lacquer, Silicon or Aluminum oxides or else a metallization based upon metallic Aluminum. For example, the cellulose central layer 90 has a thickness in the order of 17-23 μm, whilst the two external coverings 91 have a thickness in the order of 1 μm. Greater thicknesses do not allow for adequate tearing of the film, lesser thicknesses tear themselves excessively to the disadvantage of the quality of the extracted beverage. The adhesion of the two external coverings 91 to the central layer 90 occurs during the process for the application of the lacquer or else the depositing of the metallization material. The regenerated cellulose outer layer 10 has a reduced thickness and sufficient stiffness to be easily breakable when exposed to working pressures or to those perforating elements that exist in beverage extraction machines. It may be noted that in order to ensure compostability the metallization is carried out by using appropriate quantities.

In one exemplary embodiment, the outer layer 10 is a biopolymer film. Preferably, the biopolymer is coextruded, such as by means of blown film extrusion or hot casting technology. Coextrusions are composite structures that are obtained from a combination of plastic polymers supplies by differing extruders that are joined in a single strand. The adhesion occurs immediately once the single film has been produced, thereby making it possible, in a simple and flexible manner, to control the reduction of the thicknesses of the single layers and the cohesion thereof. This technique does not have the classic problems of residual solvents created by lamination and also makes it possible to easily recuperate recycled material.

Examples of possible biopolymers that are ideal for the outer layer 10 are: poly-lactic acid (PLA), poly-butylenesuccinate (PBS), poly-butylene-adipate-terephthalate (PBAT).

The biopolymer has added loads and/or nucleating agents in order to arrive at the desired degree of brittleness required. By way of example only, amongst the additives used for the purpose, there may be included talc, calcium carbonate, and/or other compostable biopolymers such as poly-hydroxybutyrate (PHB), poly-hydroxyvalerate (PHV), or, more generically, other biopolymers belonging to the poly-hydroxyalkanoate (PHA) class. Such additives are appropriately compatible with the biopolymer matrix. The object of such additives is that of rendering the biopolymer brittle to the right degree depending upon the piercing system that is included in the dispensing machine. Preferably, the biopolymer has barrier properties that are obtained directly from the co-extrusion technology. Furthermore, the barrier properties may be improved in also adding metallization, again in quantities that are ideal for ensuring compostability, or else by means of the depositing of appropriate lacquers or else by means of the depositing of one or more layers of compostable resin containing OH groups within the coextrusion.

The inner layer 20 is made of a compostable material. The inner layer 20 is a biopolymer.

In one exemplary embodiment the inner layer 20 is a compostable biopolymer with adhesion and heat-sealing properties, it is chemically similar to the material of the cup-shaped body 2, or of a portion of the cup-shaped body whereto the lid 6 is to be fastened. Such a biopolymer, if by the nature thereof is not sufficiently brittle, is loaded, that is to say it is added to, with appropriate embrittlement additives that render it suitable for the purpose, whilst not affecting the compostability thereof. For example, amongst the additives used for the purpose, there may be included talc, calcium carbonate, and/or other compostable biopolymers such as poly-hydroxybutyrate (PHB), poly-hydroxyvalerate (PHV), or, more generically, other biopolymers belonging to the poly-hydroxyalkanoate (PHA) class. Such additives are appropriately compatible with the biopolymer matrix. The object of such additives is that of rendering the biopolymer brittle to the right degree depending upon the piercing system that is included in the dispensing machine. All of the constituents of such a layer, and therefore the polymer matrix with the addition of embrittlement additives, are found to be suitable for coming into contact with foodstuffs. Preferably, the final weight of such a layer, composed of a biopolymer and embrittlement additives, is between 4 g/m² and 40 g/m², preferably between 10 g/m² and 25 g/m² and still further preferably between 12 g/m² and 20 g/m².

In some particular cases and for particular

requirements, as in the case of extremely critical products such as very fine coffee powder, the inner layer 20 of the film comprises a filtering element 30. For example, the filtering element 30 is a paper filter or else a (TNT) non-woven fabric with sealing properties. For example, the non-woven fabric is made of poly-lactic acid (PLA), preferably 100% PLA. Other suitable bio-polymers may be used for the purpose, such as, for example, poly-butylene succinate (PBS), poly-butylene-adipate-terephthalate (PBAT).

In relation to state of the art films, the film according to the present invention has a series of advantages.

With films that form state of the art lids an adhesive is always present that joins therebetween the most inner and most outer layers, generally consisting of a filter material, such as non-woven fabric or filter paper. Such adhesives are to date not suitable for coming into direct contact with foodstuffs, and even if they were, the risk of chemical release during the coffee delivery step remains, wherein the high temperature, high pressure extracted water passes through the multilayer structure of the lid. Furthermore, both the non-woven fabric and the filter paper are porous and are easily penetrated by the adhesive which therefore, both during the capsule storage step and above all during the beverage extraction step, may well come into contact with the beverage. Furthermore, such adhesives which are present within the multilayer structure of known lids in the form of thin films or nonetheless in extremely reduced quantities, so as to keep at a minimum the risk of contamination, have the sole purpose of joining the two layers that they are in contact with and do not provide any further specific functionality to the multilayer structure and to the lid itself.

Conversely, the film according to the present invention is a compostable multilayer material comprising an outer layer 10 and an inner layer 20. Preferably, the inner layer 20 is an extruded and cast biopolymer, loaded with embrittlement additives. The inner layer 20 assumes above all the function of an adhesive element, even though it is not an adhesive, not only with the outer layer 10 but also with the cup-shaped body 2. Furthermore, the inner layer 20 provides further functional properties to the particular application of the beverage capsule. In fact, insofar as it is a material with a certain brittleness, it allows for the correct opening of the capsule and the correct delivery of the beverage. Furthermore, insofar as it is an actual layer of polymer material, it confers consistency and support to the multilayer structure. Still furthermore, insofar as it has a certain brittleness, it maintains structural resistance so that, once perforated, it performs a filtering function in preventing powdery material from passing through the lid. The extruded and loaded biopolymer inner layer 20 therefore ensures, in the entirety thereof, good sealability and sealing for the lid.

As described above, in the case of particularly critical products such as very fine coffee powder, the inner layer 20 of the film comprises a filtering element 30. The filtering element is porous. With lids from the state of the art wherein an adhesive is used, the issue that may arise is in relation to the fact that such an adhesive, which lacks heat-sealing properties, sometimes penetrates the entire thickness of the porous layer and leaks out from the opposite side, thereby compromising the correct sealing of the lid, sealing that results in being not linear and continuous but rather random and related to the pattern of the filter itself. Conversely, with the film for making a lid 6 according to the present invention, wherein the inner layer 20 is an extruded and cast biopolymer loaded with embrittlement additives, precisely because it is extruded between the outer layer 10 and the porous filter element 30 whilst it is still fluid, the biopolymer penetrates through the texture of the porous element and fills the open pores of the filter element. This creates a unique layer, i.e., the inner layer 20, whereinto the filtering element 30 is at least partially incorporated within the extruded biopolymer. The extruded biopolymer, present in quantities of between 4 g/m² and 40 g/m², preferably between 10 g/m² and 25 g/m², and even more preferably between 12 g/m² and 20 g/m², forms a layer of sealing material that is suitable for ensuring the correct sealability of the lid 6 to the flange, or edge 4, of the cup-shaped body 2 of the capsule 1 also when the filtering element 30, provided with sealing properties, is completely damaged by the pressure of the sealing bars during the sealing step.

Preferably, the adhesion of the filtering element 30 to the biopolymer of the inner layer 20 is sufficiently low to allow for the delamination of the filtering element 30 under certain conditions of temperature and pressure within the cup-shaped body 2, before the delivery step or else during the delivery step. For example, the level of adhesion has values of between 0.25 and 5.00 N/15 mm, preferentially between 0.50 and 1.50 N/15 mm. The lid therefore has features regarding the peelability of the filtering element 30 from the biopolymer of the inner layer 20. In such an exemplary embodiment the lid 6 has zones at various levels of adhesion between the filtering element 30 and the biopolymer of the inner layer 20. In particular, the lid 6 has a high level of adhesion at least at the outer periphery corresponding to the sealing zone with an edge 4 of the cup-shaped body 2 and a low level of adhesion in the remaining part of the lid 6, for example within the central zone. There is therefore a delamination zone between the filtering element 30 and the biopolymer at the central zone of the lid 6.

In such an example, once the cup-shaped body 2 has been filled with a foodstuff substance, the lid 6 is sealed to the edge 4 of the cup-shaped body 2 in order to seal the capsule 1 there above. Frequently, some days after the packaging, during the storage step of the capsule 1 that has been filled with a foodstuff substance such as coffee in powder or granular form, so-called outgassing occurs. This is a natural phenomenon wherein the coffee powder loses and releases gases, principally carbon dioxide, that form within the foodstuff substance during roasting. The gas produced by the outgassing causes the pressure within the cup-shaped body 2 to increase and the action of such pressure causes separation, that is to say delamination, between the filtering element 30 and the inner layer 20 only within the low adhesion zones. At least one thrust chamber is thus formed between the filtering element 30 and the inner layer 20. During the capsule 1 extraction step in the extraction machine, the extraction liquid accumulates within the thrust chamber thereby generating a push towards the outside of the remaining layers of the laminated multilayer film, at least of the outer layer 10, layers that are pushed so as to tear against the piercing elements of the dispensing machine. A plurality of beverage outlet openings is thus easily and correctly formed within the outer layer 10. Such a solution ensures the correct opening of the capsule 1 and the correct delivery of the beverage.

In the case wherein outgassing is observed, for example for foodstuff substances that are not subject to a loss of gas, or else in the case that the outgassing may be insufficient to generate pressure for delamination within the cup-shaped body 2, the separation between the filtering element 30 and the inner layer 20 within those zones that are at low pressure nonetheless occurs during the initial capsule 1 extraction step. In fact, given that the perforation of the lid 6, and in particular the tearing thereof against the appropriate piercing elements of the dispensing machine, occurs in a moment in time after the entry of the extraction liquid through the base 4 of the capsule 1, at least one thrust chamber is formed between the inner layer 30 and the intermediate layer 20. In a fraction of a second the extraction liquid accumulates within such a thrust chamber thereby generating a push towards the outside of the remaining layers of the laminated multilayer film, at least of the outer layer 10, layers that are pushed so as to tear against the piercing elements of the dispensing machine. A plurality of beverage outlet openings 206 is thus easily and correctly formed within the outer layer 10. Such a solution ensures the correct opening of the capsule 1 and the correct delivery of the beverage. By virtue of the presence of the filtering element 30, interposed between the foodstuff substance contained within the cup-shaped body 2 and the inner layer 20, the final product passes through the filtering element 30 before intercepting the remaining inner and outer layers of the lid and the pressure of the final product is thus evenly distributed ensuring that such inner and outer layers perforate evenly. Furthermore, by virtue of the fact that t the filtering element 30 exists, the perforations within the remaining inner and outer layers of the lid are not blocked in any way.

The high level adhesion zones are on the other hand not affected by the delamination and within such zones the filtering element 30 and the inner layer 20 remain sealed together. In fact, the biopolymer that creates the inner layer 20 is cast whilst still hot onto the filtering element 30, which by definition is porous. The biopolymer penetrates through the pores of the filtering element 30 filling them at least partially, so much so that the filter element 30 is at least partially incorporated in the biopolymer. The biopolymer incorporated in the porosity of the filtering element 30 forms a sealing material layer that is ideal for ensuring the sealability of the lid 6 to the flange, or edge 4, of the cup-shaped body 2 of the capsule 1. It should be noted that delamination does not occur between the inner layer 20 and the outer layer 10 which remain sealed together.

Examples of the manufacture of the compostable multilayer film that forms the lid 6 in accordance with the present invention will now be described. It should be noted that these are laminated multilayer structures.

FIG. 3a shows a structure comprising:
outer side (that is to say the outer layer 10): embrittled paper, possibly with barrier properties not deriving from depositing and/or metallization;
inner side (that is to say the inner layer 20 with the filtering element 30): non-woven fabric incorporated (embedded) into the extruded biopolymer, cast and loaded with embrittlement additives.

FIG. 3b shows a structure comprising:
outer side (that is to say the outer layer 10): embrittled paper, possibly with barrier properties not deriving from depositing and/or metallization;
inner side (that is to say the inner layer 20 with the filtering element 30): filter paper incorporated (embedded) into the extruded biopolymer, cast and loaded with embrittlement additives.

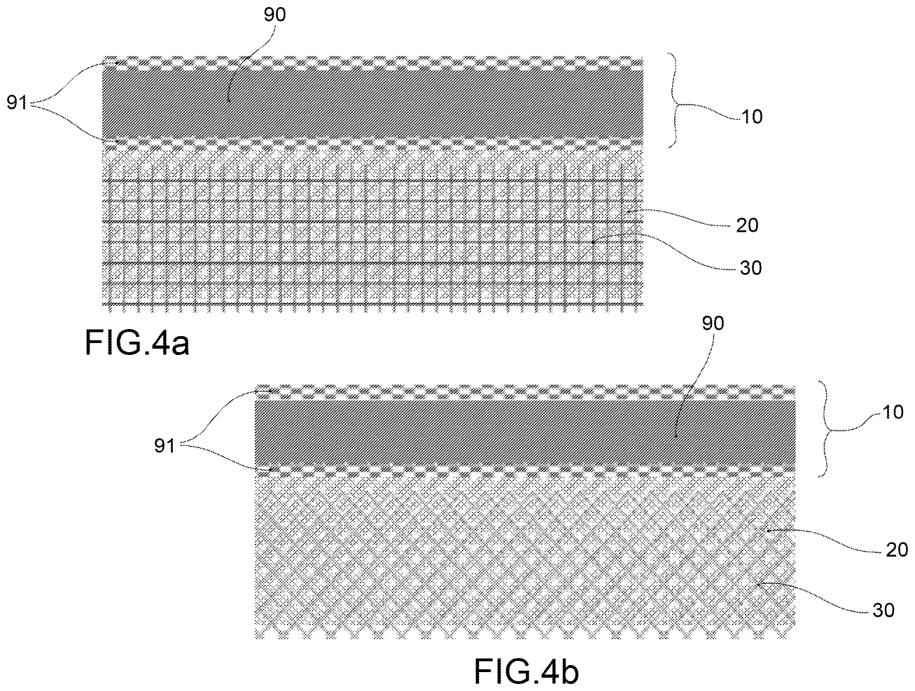

FIG. 4a shows a structure comprising:
outer side (that is to say the outer layer 10): barrier paper or regenerated cellulose with barrier properties;
inner side (that is to say the inner layer 20 with the filtering element 30): non-woven fabric incorporated (embedded) into the extruded biopolymer, cast and loaded with embrittlement additives.

FIG. 4b shows a structure comprising:
outer side (that is to say the outer layer 10): barrier paper or regenerated cellulose with barrier properties;
inner side (that is to say the inner layer 20 with the filtering element 30): filter paper incorporated (embedded) into the extruded biopolymer, cast and loaded with embrittlement additives.

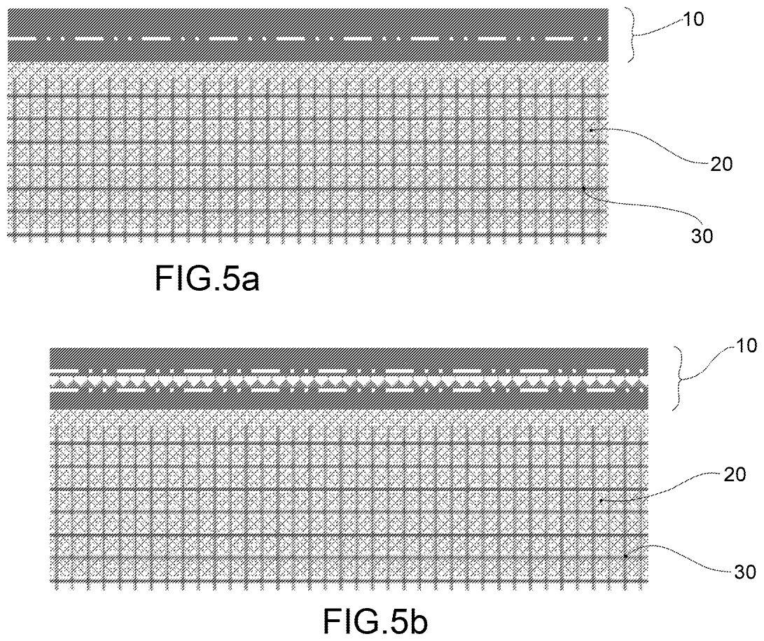

FIG. 5a shows a structure comprising:
outer side (that is to say the outer layer 10): brittle biopolymer film blown extruded or hot cast;
inner side (that is to say the inner layer 20 with the filtering element 30): non-woven fabric incorporated (embedded) into the extruded biopolymer, cast and loaded with embrittlement additives.

FIG. 5b shows a structure comprising:
outer side (that is to say the outer layer 10): brittle biopolymer film blown extruded or hot cast with barrier properties;
inner side (that is to say the inner layer 20 with the filtering element 30): non-woven fabric incorporated (embedded) into the extruded biopolymer, cast and loaded with embrittlement additives.

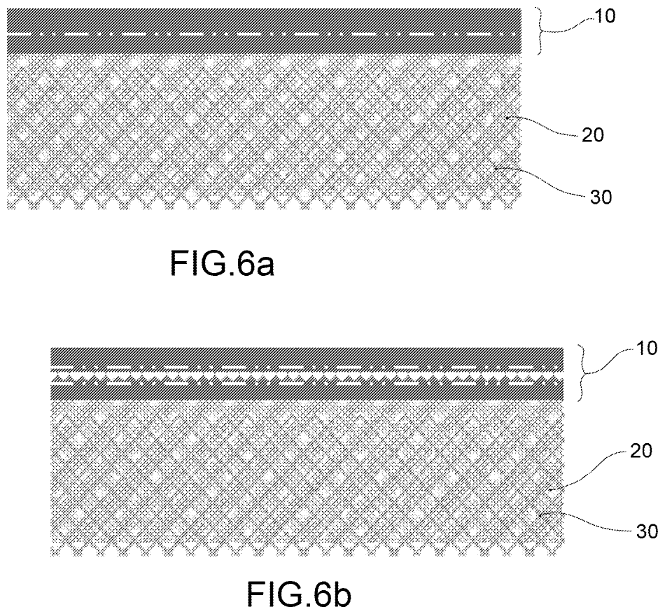

FIG. 6a shows a structure comprising:
outer side (that is to say the outer layer 10): brittle biopolymer film blown extruded or hot cast;
inner side (that is to say the inner layer 20 with the filtering element filter 30): paper incorporated (embedded) into the extruded biopolymer, cast and loaded with embrittlement additives.

FIG. 6b shows a structure comprising:
outer side (that is to say the outer layer 10): brittle biopolymer film blown extruded or hot cast with barrier properties;
inner side (that is to say the inner layer 20 with the filtering element 30): filter paper incorporated (embedded) into the extruded biopolymer, cast and loaded with embrittlement additives.

The object of the present invention is also a compostable capsule 1 for pressure-extractable beverages, comprising a cup-shaped body 2 closed by a compostable sealing lid as described above.

Innovatively, a film for a lid of a capsule for making infusion or soluble beverages according to the present invention is at the same time compostable, preferably devoid of adhesives and easily broken in order to ensure correct opening thereof by means of perforation.

Advantageously, in the version that is devoid of adhesives, there are no risks to the beverage of contamination.

Advantageously, furthermore, by virtue of the fact that the adhesive is substituted by a biopolymer, advantages are gained during the packaging step when the lid tapers under the pressure of the sealing bars during sealing between the lid and capsule body, above all when the filtering layer is present. In the case of state of the art lids, insofar as the filtering element is porous, at certain points the adhesive may penetrate the entire thickness of the filter: zones of contact are thus created between capsule body and adhesive, and given that the adhesive is not heat-sealing, within such areas sealing does not occur. These sporadic zones of contact between adhesive and capsule body may compromise the hermetic sealing of the capsule. Also in the case of the lid according to the present invention, insofar as the filtering element is porous, the biopolymer penetrates the entire thickness of the filter and comes into contact with the capsule body. Nevertheless, given that the biopolymer is heat-sealing and thermically/chemically compatible both with all of the layers of the film that form the lid and with the capsule body material, a homogeneous seal is always ensured, with no points of discontinuity between the lid and capsule body.

It is understood that a person skilled in the art could make modifications to the capsule for making infusion or soluble beverages described above, all of which are contained within the scope of protection as defined by the following claims.

What is claimed is

1-15. (canceled)

16. A method for manufacturing a compostable film for sealing a capsule for making beverages, the method comprising:
arranging an outer barrier layer made of a compostable material, the compostable material being paper, or regenerated cellulose;
arranging a filtering element; and
extruding and casting, directly onto the outer barrier layer, an inner layer, intended to come into contact with the capsule to be sealed, made of a compostable biopolymer with heat-sealing properties so that the filtering element is at least partially incorporated in the compostable biopolymer.

17. The method of claim 16, further comprising extruding the inner layer between the outer barrier layer and the filtering element whilst the inner layer is still fluid, the compostable biopolymer penetrating through a texture of the filtering element and filling open pores of the filtering element.

18. The method of claim 16, wherein the outer barrier layer is made of paper and regenerated cellulose.

19. The method of claim 16, wherein the outer barrier layer has a thickness of between 10 μm and 120 μm.

20. The method of claim 16, wherein the outer barrier layer has a thickness of between 19 μm and 85 μm.

21. The method of claim 16, wherein the inner layer is a biopolymer made brittle by addition of additives selected from: talc, calcium carbonate, and polyhydroxyalkanoate (PHA) polymers, optionally the polyhydroxyalkanoate (PHA) polymers being polyhydroxybutyrate (PHB) or polyhydroxyvalerate (PHV).

22. The method of claim 16, wherein the inner layer has a final weight of between 4 g/m² and 40 g/m².

23. The method of claim 16, wherein the inner layer has a final weight of between 10 g/m² and 25 g/m².

24. The method of claim 16, wherein the inner layer has a final weight of between 12 g/m² and 20 g/m².

25. The method of claim 16, wherein the outer barrier layer and the inner layer are mutually coupled without the use of adhesives.

26. The method of claim 16, wherein the filtering element is a non-woven fabric, the filtering element being partially peelable from the compostable biopolymer within a low adhesion delamination zone between the filtering element and the compostable biopolymer, the low adhesion delamination zone being a central portion.

27. The method of claim 26, wherein the non-woven fabric is made of poly-lactic acid (PLA) or poly-butylene succinate (PBS) or poly-butylene-adipate-terephthalate (PBAT).

28. The method of claim 26, wherein, within the low adhesion delamination zone, adhesion has values of between 0.25 and 5.00 N/15 mm.

29. The method of claim 26, wherein, within the low adhesion delamination zone, adhesion has values of between 0.50 and 1.50 N/15 mm.

30. The method of claim 26, wherein the filtering element is permanently joined to the compostable biopolymer at least within a high adhesion zone between the filtering element and the compostable biopolymer, the high adhesion zone being a peripheral portion.

31. The method of claim 30, wherein, within the high adhesion zone, adhesion is greater than 5.00 N/15 mm.

32. A compostable film for sealing a capsule for making beverages, the compostable film being obtained by a method comprising:
arranging an outer barrier layer made of a compostable material, the compostable material being paper, or regenerated cellulose;
arranging a filtering element; and
extruding and casting, directly onto the outer barrier layer, an inner layer, intended to come into contact with the capsule to be sealed, made of a compostable biopolymer with heat-sealing properties so that the filtering element is at least partially incorporated in the compostable biopolymer.

33. A compostable capsule for pressure-extractable beverages, comprising a cup-shaped body that defines an inner volume in which there is contained at least one foodstuff substance to be infused or dissolved, closed with a lid made with the compostable film of claim 32, wherein the lid has:
a high level of adhesion between the filtering element and the compostable biopolymer at least at an outer periphery at a sealing zone with an edge of the cup-shaped body, and
a low level of adhesion between the filtering element and the compostable biopolymer within a central zone.
